(19) United States
(12) Patent Application Publication
(10) Pub. No.: US 2018/0052512 A1
(43) Pub. Date: Feb. 22, 2018

(54) BEHAVIORAL REHEARSAL SYSTEM AND SUPPORTING SOFTWARE

(71) Applicant: Thomas J. Overly, Grand Rapids, MI (US)

(72) Inventor: Thomas J. Overly, Grand Rapids, MI (US)

(21) Appl. No.: 15/238,511

(22) Filed: Aug. 16, 2016

(51) Int. Cl. G06F 3/01; G06F 3/16; G06T 13/40; G06T 19/00; G09B 19/00; A63F 13/825; A63F 13/213; A63F 13/215; A63F 13/25; A63F 13/42; A63F 13/26

(52) U.S. Cl. CPC G06F 3/012; G06F 3/167; G06T 13/40; G06T 19/006; G09B 19/00; G02B 27/017; A63F 13/213; A63F 13/215; A63F 13/25; A63F 13/42; A63F 13/26; A63F 13/825

(57) ABSTRACT

A behavioral rehearsal system in which full body tracking, facial tracking and voice modulation technology are used with virtual reality hardware and software to allow a therapist, or “leader,” to interact directly with a patient, or “subject,” in a virtual reality setting that is designed to simulate the actual environments and individuals the subject has experienced difficulty with. One or more avatars are controlled by the leader in these environments to simulate the form, dress, speech and mannerisms of a person or persons appropriate to the setting and circumstances identified in the subject's presenting symptoms. Therapists or leaders are able to interact with their subjects in a way that was previously impossible, through real-time social interaction that is specific to the subject's needs.

### FIELD OF INVENTION

The present invention relates to the field of behavioral therapy.

### BACKGROUND

Behavioral therapy involves helping individuals with a variety of mood, learning, and personality disorders develop new interpersonal and communication skills in order to better interact with others in their daily lives. In traditional behavioral therapy, behavioral rehearsals, or “role plays” are often conducted in session. During these rehearsals, the therapist guides the subject through problem areas with interactive dialogue. Additionally, behavioral homework is often giving and prompting the subject to carry out new interactions in the actual environments in which he or she has been experiencing difficulty.

Virtual reality hardware and software has previously been used by therapists to administer exposure therapy for anxiety-spectrum disorder, including PTSD, specific phobias, and social anxiety disorder. For example, a patient with a fear of heights might be gradually exposed to virtual reality scenarios involving heights until they are able to adequately habituate to the stimulus. Similarly, a patient with claustrophobia may be placed in a small virtual space which is gradually reduced in size over sessions until he or she is able to habituate to the smaller space to the extent that his or her anxiety has been reduced to a manageable level. In both cases, clients are able to perform tasks in their lives that had previously been disrupted due to their anxiety symptoms.

### SUMMARY OF THE INVENTION

In the method and system of present invention, full body tracking, facial tracking and voice modulation technology are used with virtual reality hardware and software to allow a therapist, or “leader,” to interact directly with a patient, or “subject,” in a virtual reality setting that is designed to simulate the actual environments and individuals the subject has experienced difficulty with. One or more avatars are controlled by the leader in these environments to simulate the form, dress, speech and mannerisms of a person or persons appropriate to the setting and circumstances identified in the subject's presenting symptoms. Therapists or leaders are able to interact with their subjects in a way that was previously impossible, through real-time social interaction that is specific to the subject's needs.

These and other objects, advantages and features of the invention will be more fully understood and appreciated by reference to the description of the preferred embodiments and drawings set forth herein.

### BRIEF DESCRIPTION OF THE DRAWINGS

FIG. 1 is a perspective view of a patient or subject wearing a visual display device and audio output device;

FIG. 2 is a perspective view of an omnidirectional treadmill;

FIG. 3 is a perspective view of a leader wearing body tracking gear, facial tracking gear and an audio input device, and of a following avatar in a virtual reality environment;

FIG. 4 is a perspective view of a leader and avatar as in FIG. 3, but in a different body position;

FIG. 5 is a perspective view of a leader's face, indicating the points which are tracked for emulation by the avatar;

FIG. 6 is a perspective view of a leader and avatar showing facial tracking of the leader by the avatar;

FIG. 7 is a diagram showing the relationship of the various components used in the preferred embodiment; and

FIG. 8 is a diagram of the components used in creating populated interactive environment modules.

### DESCRIPTION OF THE PREFERRED EMBODIMENTS

System Overview

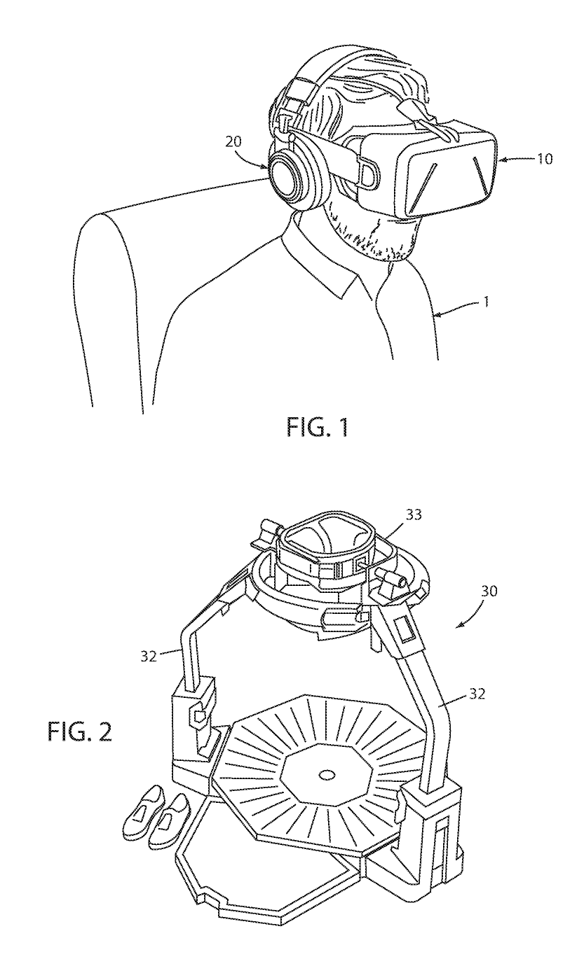

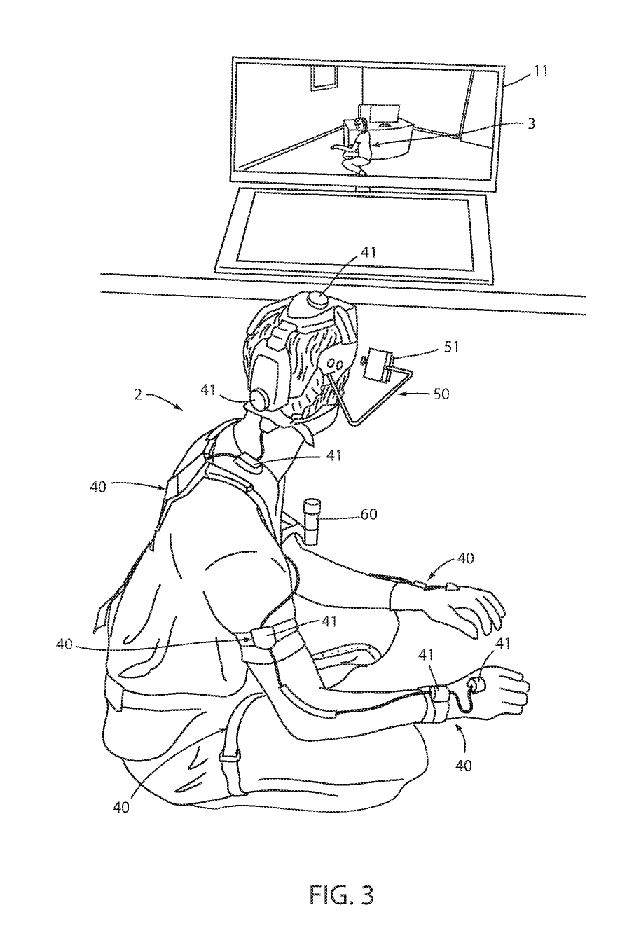

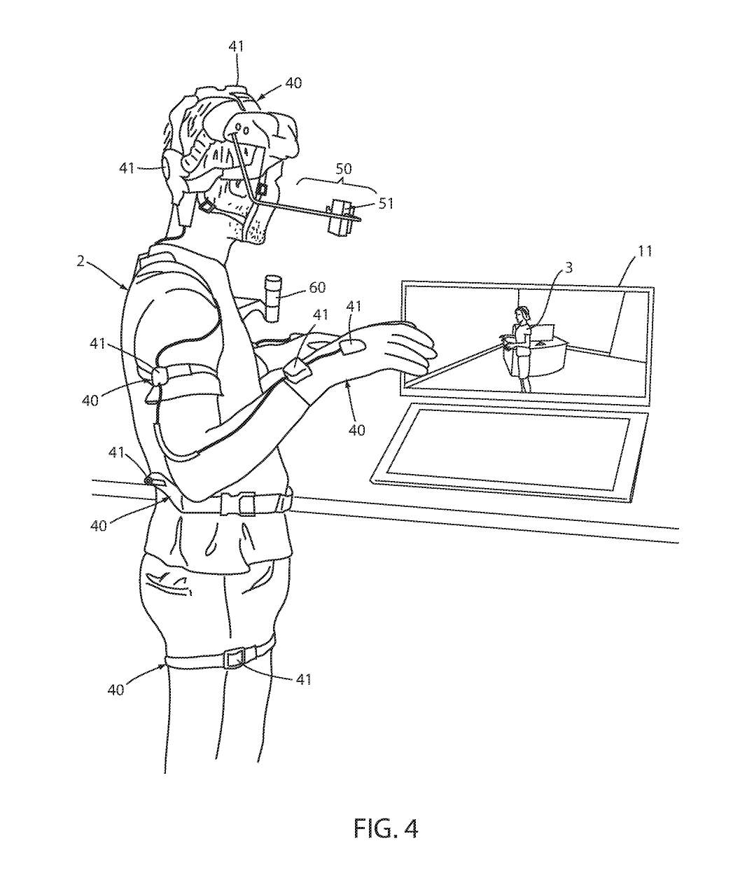

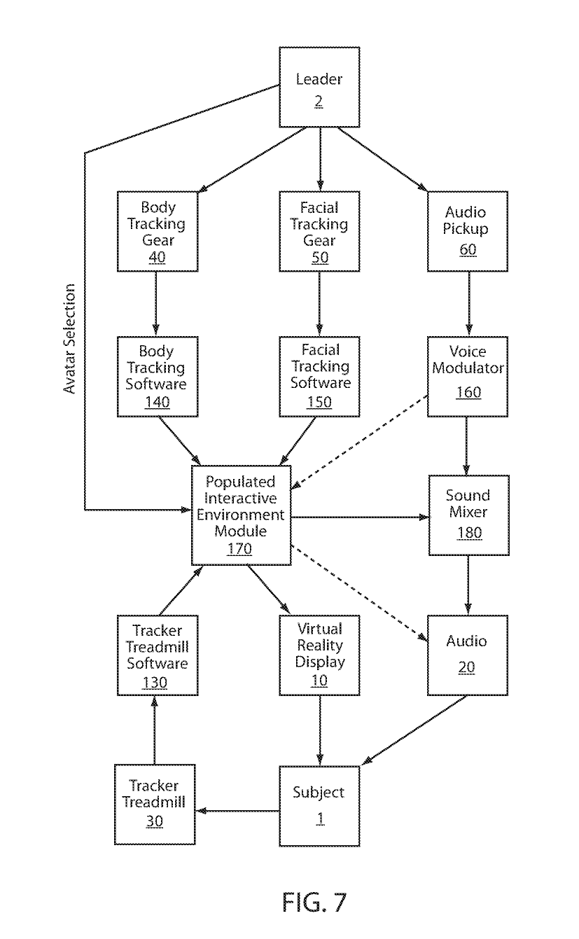

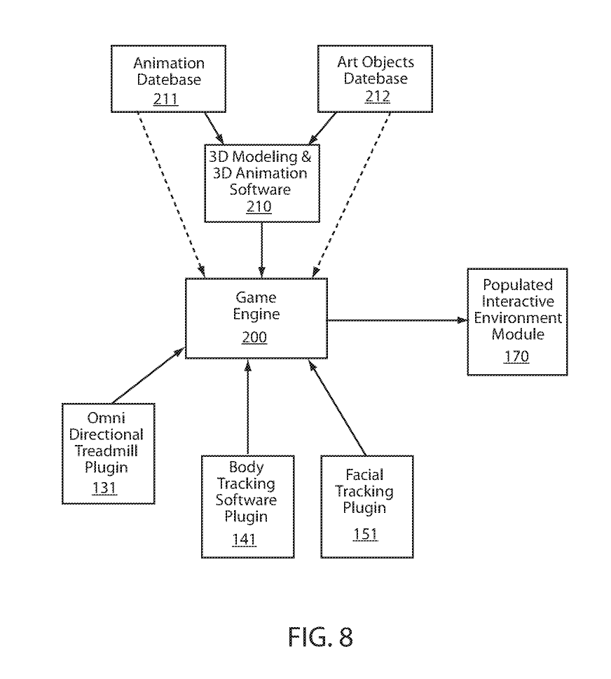

In the preferred embodiments, the subject (typically a patient) 1 employs a virtual reality video display 10 with associated audio output 20 (FIG. 1), and a location tracker, preferably an omni-directional treadmill 30 (FIG. 2). A leader 2, who may be the therapist or a person assisting the therapist, employs body tracking gear 40 (FIGS. 3, 4), facial tracking gear 50 (FIGS. 4, 5, 6) and an audio input device 60 (FIGS. 3, 6). The leader's body motions are communicated by the body tracking gear 40 to full body tracking software 140 and his or her facial expressions are communicated by the facial tracking gear 50 to facial tracking software 150 (FIG. 6). The leader's voice is picked up by audio input device 60 and communicated to voice modulator 160 (FIG. 7). An appropriate scene and one or more avatars 3 (FIGS. 2, 3) are programmed into and generated by one of several populated interactive environment modules 170 (FIG. 7), through the use of a game engine 200 programed by 3D modeling and animation software, animation and art object databases 211 and 212, and communication plug-ins 131, 141 and 151 (FIG. 8).

The body tracking software 140 and the facial tracking software 150 map the real-time body and facial movement of the leader 2 directly onto a virtual avatar 3, created to specification by the therapist in the populated interactive environment module 170 (FIG. 7). The body movements and facial expressions of Leader 2 are thus translated into the controlled avatar 3 in the populated interactive environment module 170. The voice modulator 160 feeds the appropriately modulated voice of the leader 2 to a sound mixer 180, where it is mixed with virtual ambient sound which has been programmed into the populated interactive environment module 170.

The populated interactive environment module scene 170 including any avatar(s), are displayed on display 10 (FIG. 7). The mixed voice and ambient sound are fed by sound mixer 180 to audio output 20. (An alternative is discussed below, whereby the modulated voice would be mixed in the populated interactive environment module and communicated from there to the audio output device 20.) The appearance and voice which the subject 1 sees and hears thus match the characteristics of the avatar, and are no longer recognizable to the subject 1 as the movement and voice of the Leader 2. Multiple virtual avatars may be used. The leader may switch between avatars, providing voice and animation to one at a time, or a separate therapist or “leader” may be used for each avatar.

The subject's location in the virtual reality scene is determined by subject tracker 30 and associated subject tracker software 130, which is connected to the populated interactive environment module 170. The orientation of said populated interactive virtual environment as seen in said virtual reality display 10 changes based on the input from said subject tracker 30 and said subject tracker software 130, giving the subject 1 the sense of moving about in said populated interactive virtual environment. A separate display 11, such as the monitor shown in FIGS. 3, 4 and 6 is preferably provided for the leader(s) 2 so the leader(s) can see exactly what the subject 1 sees.

### SYSTEM COMPONENT LISTING

Video display 10 for subject 1

Video display 11 for Leader 2

Audio output 20 for subject 1

Subject Tracker 30 for subject 1

Subject Tracker software 130
Tracker software plug in 131

Body tracking gear 40 for leader 2

Body tracking software 140
Body tracking software plug in 141′

Facial tracking gear 50 for leader 2

Facial tracking software 150
Facial tracking software plug in 151

Audio input device 60 for leader 2

Voice modulator 160

Sound mixer 180

Populated interactive environmental module 170

Game Engine 200 for generating populated interactive environment modules 170

3D modeling & animation software 210
Animation Database 211
Art objects database 212

### DETAILED DESCRIPTION

Video display 10 for subject 1 preferably comprises a head worn display. While one or more video monitors could be used, especially if arranged to partially or totally surround the subject, the head worn display very effectively shuts out the extraneous environment and focuses the subject's attention exclusively on the populated interactive environment being displayed.

Video display 11 for Leader 2, on the other hand is preferably a video monitor as shown in FIGS. 3, 4 and 6. This enables the leader to see the subject, and to see what the subject is seeing.

The audio output 20 for subject 1 is preferably a set of head phones. While speakers could be used, headphones shut out extraneous ambient sound, and focus the subject's attention on the ambient sounds and the avatar voices being generated by the interactive module 170 and voice modulator 160.

Subject tracker 30 tracks movement of subject 2 relative to the interactive environment being displayed by interactive environment module 170. Subject tracker 30 preferably comprises an omni-directional treadmill (FIG. 2), with a tracking base 31 which tracks attempted movement of subject 1 in any direction while keeping the subject safely and securely in place with-in a restraining belt 33 positioned on support arms 31. The omni-directional subject tracker 30 includes subject tracker software 130 which communicates with interactive environment module 170, to translate foot movements by subject 1 into motion within the virtual reality environment being displayed by module 170 on the subject's display 10. Thus the subject experiences movement within the virtual reality environment which he or she sees.

The body tracking component or gear 40 sends data from 32 sensors 41 which are positioned at various points on the leader's body (FIGS. 3, 4). Thus sensors 41 are shown on the back and top of the leader's head, the leader's hands and arms above the elbows, the leader's back, front, legs, and ankles. The positional output of these sensors are fed to the full body tracking software 140 and then communicated to the avatar 3 which the leader has chosen to control. By moving about his or her actual environment, relative to a target spot, the leader causes the controlled avatar to move about the virtual environment being displayed by module 170 on subject display 10 and the leader's display 11. By changing his or her body configuration, the leader changes the body configuration of the controlled avatar 3.

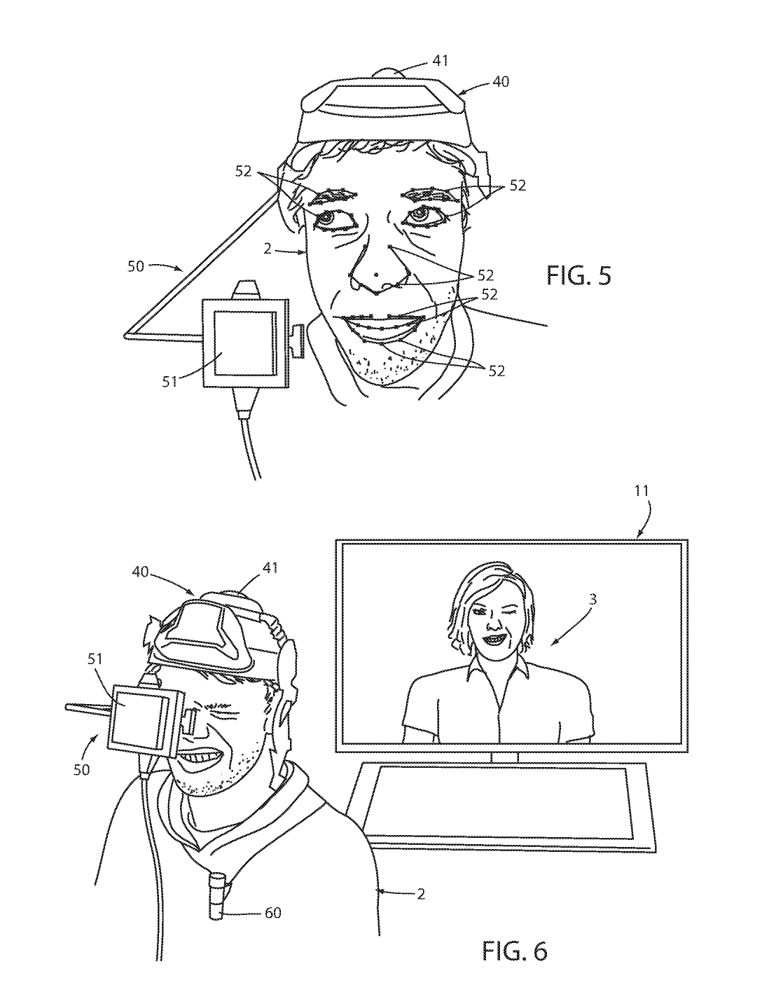

The facial tracking component 50 uses a head-mounted camera 51 that maps all real-time facial movement to the face of the virtual avatar, through facial tracking software 150 communicating with the virtual environment module 170 (FIGS. 5, 6, 7), allowing the leader to fully emote and converse, with each detail of facial movement being displayed through the controlled avatar 3. FIG. 5 shows the various mouth, nose and eyebrow points 52 which facial tracking software 150 tracks.

The audio input device 60 for leader 2 is preferably a lapel microphone. Audio input device 60 transmits the leader's voice to the voice modulator 160 which enables the therapist's voice to be output in real-time in a voice that matches the characteristics of the avatar 3 being controlled. Voice modulator 160 is preferably a hardware item. Such items are based on the principles of a synthesizer. Preferably, the output of voice modulator 160 is communicated to a mixer 180, which also receives virtual ambient sound being generated by the virtual environment module 170. The sound from both sources is mixed and then fed to the audio output headset worn by the subject 1. However, voice modulation software is also an option for voice modulator 160. In that case, voice modulator 160 would communicate with the populated interactive environment module 170 where the mixing with virtual ambient sound would be accomplished. The populated interactive environment module 170 would then feed the mixed sound to the audio output head phones 20. (See the dashed line path in FIG. 7.)

The populated interactive environmental modules 170 are produced using game engine software 200, and various supporting software modules (FIG. 8). Unreal Engine 4 is an example of such a game engine. Typically, a therapist will indicated the type of environment he or she would like to use, the number and type of people desired, and which are to be avatars. The programmer uses a 3D modeling and animation software 210 to program the environment. Autodesk Maya is an example of such software. The programmer may incorporate particular animations from database 211 and/or particular objects from database 212 into the modeling process using software 210, or may incorporate animations and objects directly from those databases into the game engine 200.

Full body tracking communication software plugin 141 and facial tracking communication plugin 151 are incorporated into game engine 200. The avatar(s) is programmed to communicate with full body tracking software and hardware though said full body tracking communication software plugin 141, and is programmed to communicate with facial tracking software and hardware through said facial tracking communication plugin 142, such that the avatar(s) in any module 170 created using game engine 200 will be receptive to program instructions received from the full body tracking software 140, and the facial tracking software 150. A subject tracker communication software plug in 131 is also incorporated into game engine 200 for responding to instructions from said subject tracker software 130. The populated interactive environment software module is programmed to respond to input from said subject tracker software, which it generates in response to input from said subject tracker hardware, in such a way that the orientation of said populated interactive virtual environment as seen in said virtual reality display 10 changes, giving the subject the sense of moving about in said populated interactive virtual environment.

The programmer can incorporate animated people into module 170 whose actions and responses are entirely programmed into the module. These animated characters will be programmed to move, speak or otherwise respond to particular programed signals which are triggered by the actions of any avatar in the module. One or more avatars will be created as appropriate. These will be subject to control by the motions of a leader or leaders. Some of the characters can be switchable from program controlled and responsive mode to avatar mode.

Many different populated interactive environment modules can be created. The system may be provided with a number of pre-packaged modules. In addition, a user of the system will be able to program or have programmed additional custom modules to deal with additional interpersonal and environmental situations.

Methods of Use

Within the virtual environments, the therapist or leader interacts with subjects by using modules 170 reproducing problematic social interactions that match those reported by the subject. Through a virtual reality head-mounted display 10 and audio head set 20, the subject sees and hears the therapist's avatar display behaviors and communication that simulate those that the subject has reported difficulty with. If the subject exhibits the previously reported problem behavior, the therapist pauses the program and prompts the subject to employ a different, behaviorally acceptable approach to the problem being explored. These rehearsals are then varied and repeated until the subject has learned to interact with individuals or groups in a manner that will no longer disrupt their lives.

As an example, an adult male subject may have difficulty dealing with women superiors in the work place. Such difficulties may lead to dismissal if he cannot overcome this psychological problem. To treat the subject, the therapist might want a conference room setting, with animated characters sitting around a conference room table, and a middle aged female avatar which is controlled by the leader. Even though the leader is a male, the subject will see and hear only a female with a female voice. Through varied and repeated rehearsals, the subject will gradually be conditioned to deal appropriately with workplace issues which may arise between an adult male and his female supervisor.

Of course it is understood that the forgoing are preferred embodiments of the invention, and that variations in the system and methods of use may be employed within the scope of the appended claims.

1. A system for creating virtual reality populated interactive environment comprising:
full body tracking hardware, facial tracking hardware, an audio input device and a voice modulator for use by a leader;
a populated interactive environment software module for generating a populated interactive virtual environment; said populated interactive environment software module including at least one avatar programmed into its said virtual environment;
body tracking software operably connected to, and for receiving input from, said full body tracking hardware; said full body tracking software being operably connected to said populated interactive environment software module, for mapping said input from said full body tracking software onto said avatar in said populated interactive environment software module;
facial tracking software operably connected to, and for receiving input from, said facial tracking hardware; said facial tracking software being operably connected to said populated interactive environment software module, for mapping said input from said facial tracking software onto said avatar in said populated interactive environment software module;
said audio input device being operably connected to said voice modulator, whereby the voice input of a leader into said audio input device is converted to a voice appropriate to said avatar in said populated interactive environment software module;
a virtual reality video display for use by a subject, said virtual reality display being operably connected to said populated interactive environment software module, for displaying a populated interactive virtual environment created by said populated interactive environment software module;
an audio output device for use by a subject, said audio output device being operably connected to said voice modulator;
whereby a leader can interact directly with a subject in a virtual reality environment.

2. The system of claim 1 comprising:
tracker hardware for use by a subject;
tracker software operably connected to, and for receiving input from, said tracker hardware; said tracker software being operably connected to said populated interactive environment software module, for mapping said input from said tracker software, whereby the orientation of said populated interactive virtual environment as seen in said virtual reality display changes, giving the subject the sense of moving about in said populated interactive virtual environment.

3. The system of claim 2 in which: said tracker comprises an omni-directional treadmill.

4. The system of claim 3 which includes: a sound mixer; said voice modulator being operably connected to said audio output device through said sound mixer; said populated interactive environment software module being programmed to generate ambient sound in said populated virtual reality environment, and being operably connected to said mixer whereby the sound from said voice modulator and the sound from said populated interactive environment software module are mixed in said mixer; said sound mixer being operably connected to said audio output.

5. The system of claim 4 in which: said sound mixer comprises software within said populated interactive environment module.

6. The system of claim 5 in which: said virtual reality video display comprises a head worn display and said audio output comprises head phones.

7. The system of claim 6 which comprises: a video monitor operably connected to said populated interactive environment software module, whereby a leader can see the same populated interactive virtual environment which is seen by a subject.

8. The system of claim 1 which includes: a sound mixer; said voice modulator being operably connected to said audio output device through said sound mixer; said populated interactive environment software module being programmed to generate ambient sound in said populated virtual reality environment, and being operably connected to said mixer whereby the sound from said voice modulator and the sound from said populated interactive environment software module are mixed in said mixer; said sound mixer being operably connected to said audio output.

9. The system of claim 8 in which: said sound mixer comprises software within said populated interactive environment module.

10. The system of claim 1 in which: said virtual reality video display comprises a head worn display and said audio output comprises head phones.

11. The system of claim 1 which comprises: a video monitor operably connected to said populated interactive environment software module, whereby a leader can see the same populated interactive virtual environment which is seen by a subject.

12. The system of claim 1 comprising: a plurality of said populated interactive environment software modules.

13. A method for creating populated interactive environment software modules in which a first person can become an avatar in a virtual reality environment and a second person can interact said avatar in said environment, said method comprising: using 3D modeling and animation software to program objects and at least one avatar into a populated interactive environment in a game engine; incorporating a full body tracking communication software plugin and a facial tracking communication plugin into said game engine; programing said avatar to communicate with full body tracking software and hardware though said full body tracking communication software plugin; programing said avatar to communicate with facial tracking software and hardware through said facial tracking communication plugin; incorporating a subject tracker communication software plugin into said game engine for responding to instructions from said subject tracker software; programming said populated interactive environment software module to respond to input from said subject tracker software, which it generates in response to input from said subject tracker hardware, in such a way that the orientation of said populated interactive virtual environment as seen in a virtual reality display changes, giving the subject the sense of moving about in said populated interactive virtual environment.

14. A method of providing behavioral therapy to a subject having presenting symptoms comprising:
using full body tracking, facial tracking and voice modulation technology to allow a therapist, or “leader” assisting the therapist, to control one or more avatars in a populated interactive virtual environment appropriate to the subject's presenting symptoms, said virtual environment having been generated by a populated interactive environment software module, and said avatars having been programmed to simulate the form and dress of a person or persons appropriate to said subject's presenting symptoms; using an audio input and voice modulator and operably connecting said voice modulator to an audio output device used by said subject, thereby allowing said therapist or said leader to speak to said subject in a voice appropriate to said avatar; providing the subject with a virtual reality display for viewing said populated virtual interactive environment; enabling said therapist to cause said avatar to act in ways which provoke said subject's presenting symptoms, and to provide instruction and repetition through such virtual interaction which assist the subject in adopting appropriate responses and attitudes to such provocations when they are encountered by the subject in reality.

15. The method of claim 14 comprising: providing said subject with a subject tracker which provides input to subject tracker software operably connected to said populated interactive virtual environment software module, said populated interactive environment software module having been programmed to respond to input from said subject tracker software in such a way that the orientation of said populated interactive virtual environment as seen by said subject in said virtual reality display changes, giving said subject the sense of moving about in said populated interactive virtual environment.

16. The method of claim 14 wherein: said subject tracker comprises an omni-directional treadmill.

17. The method of claim 16 in which: said leader and/or therapist uses a video monitor operably connected to said populated interactive environment software module, whereby said leader and/or therapist can see the same populated interactive virtual environment which is seen by a subject.

18. The method of claim 17 in which: said virtual reality video display comprises a head worn display and said audio output comprises head phones.

19. The method of claim 14 in which: said leader and/or therapist uses a video monitor operably connected to said populated interactive environment software module, whereby said leader and/or therapist can see the same populated interactive virtual environment which is seen by a subject.

20. The method of claim 19 in which: said virtual reality video display comprises a head worn display and said audio output comprises head phones.
